(19) United States
(12) Patent Application Publication
(10) Pub. No.: US 2025/0342307 A1
(43) Pub. Date: Nov. 6, 2025

(54) ALT-TEXT IMPROVEMENT: DECORATIVE ELEMENTS DETECTION & FILTRATION

(71) Applicant: Dell Products L.P., Round Rock, TX (US)

(72) Inventors: Iam Palatnik de Sousa, Rio de Janeiro (BR); Kranti Uppala, Westwood, MA (US); Mahi Ismail, New Cairo (EG); Shary Beshara, Cairo (EG)

(21) Appl. No.: 18/656,315

(22) Filed: May 6, 2024

(51) Int. Cl. G06F 40/166; G06F 40/279; G06T 7/11; G06T 7/50; G06T 7/70; G06T 11/20

(52) U.S. Cl. CPC G06F 40/166; G06F 40/279; G06T 7/11; G06T 7/50; G06T 7/70; G06T 11/206

(57) ABSTRACT

A method for improving a textual description, including, receiving an image and alt-text, and the alt-text has been generated based on the image, extracting, from the alt-text, a description of an object that is included in the image, detecting in the image, using the description, where the object is located, estimating a relevance of the object, and when the relevance fails to meet a relevance threshold, generating modified alt-text by removing the description of the object from the alt text.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to improvements in alt-text usability. More particularly, at least some embodiments relate to systems, hardware, software, computer-readable media, and methods, for processing alt-text to make the alt-text more useful and informative for users.

### BACKGROUND

Alternative text, or simply ‘alt-text,’ is commonly provided for images on the web, such as on websites for example. Alt-text may be employed when, for example, an image cannot be rendered in a visible form for some reason. As another example, alt-text for an image may be employed for use by visually impaired users who may not be able to see the image.

However, the quality of alt-text may vary widely from one situation to another. For example, a passage of alt-text may accurately describe an image, but may omit important context that would make the alt-text concerning the image more useful to a user. For example, alt-text for an image may refer to ‘a car traveling on a paved surface.’ However, if the image is of a racecar on a racetrack, the alt-text could be improved by adding contextual text, so that, for example, improved alt-text might read ‘a racecar speeding along a racetrack in a car race.’ The latter alt-text thus provides richer information for the user because it includes context for the image, and is not simply a generic description of the image. As the foregoing example illustrates, poor quality alt-text may negatively impact web accessibility for visually impaired users, leading to an unsatisfactory online user experience.

As a final example, the inclusion of descriptions of decorative, or irrelevant, elements in image alt-texts on webpages misleads search engines, resulting in incorrect search results. The inclusion of irrelevant elements in alt-text may also reduce the SEO (search engine optimization) capabilities and usability of a webpage.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of heatmaps showing the localization, depth and sharpness of a given object (laptop) in the input image, according to one embodiment.

FIG. 2 discloses an algorithm for a few shot prompt, according to one embodiment.

FIG. 3 discloses an example architecture and method, according to one embodiment.

FIG. 4 discloses an example computing entity configured and operable to perform any of the disclosed methods, processes, and operations.

### DETAILED DESCRIPTION OF SOME EXAMPLE EMBODIMENTS

Embodiments disclosed herein generally relate to improvements in alt-text usability. More particularly, at least some embodiments relate to systems, hardware, software, computer-readable media, and methods, for processing alt-text to make the alt-text more useful and informative for users.

One example embodiment comprises a method for processing alt-text concerning an image. In one embodiment, the method may be performed after the alt-text has already been written, or may be used to guide the generation of new alt-text. In one embodiment, the method comprises the operations: receiving, as input, an image and alt-text that has been generated for that image; extracting a list of objects from descriptions included in a given alt-text; detecting where the objects are in the image to which the alt-text pertains; estimating the relevance of each object in the image; removing any irrelevant object(s) from the image; and, generating new/modified alt-text corresponding to the modified image by removing, from the original alt-text, any alt-text pertaining to the removed object(s).

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that alt-text may be processed to improve the relevance and usability of the alt-text. An embodiment may enable an improved web access experience for a visually impaired user. An embodiment may enable improved SEO results for a website. Various other advantages of one or more example embodiments will be apparent from this disclosure.

### A. Overview of Some Aspects of One Example Embodiment

The following is an overview of some aspects of one example embodiment. This discussion is not intended to limit the scope of the claims or this disclosure, or the applicability of the embodiments, in any way.

One embodiment comprises an approach for identifying, and removing, decorative object descriptions from alt-text. An embodiment may employ ML (Machine Learning) algorithms and LLMs (Large Language models) to detect objects from the alt-text input, which may comprise the alt-text and an image to which the alt-text corresponds, evaluate their relevance to the image context, and remove them accordingly.

As noted earlier herein, poor alt-text is commonly provided for images on the web, and may negatively affect web accessibility for visually impaired users leading to an unsatisfactory online user experience. Thus, one embodiment may operate to improve web accessibility by enhancing the quality of the auto-generated alt-text. In an embodiment, this may be performed by detecting the decorative elements in the image and removing their corresponding descriptions from the auto-generated alt-text relating to that image. Thus, an embodiment may operate to preserve only the core elements of the image, while disregarding, and removing, the decorative elements that might impact the meaning of the alt-text and thus confuse a user.

In more detail, an embodiment may comprise the following operations: receiving an image, with its generated alt-text, as input, where the alt-text may have been auto-generated; using different ML models to analyze the elements included in the alt-text; identifying a relevance score for each element; detecting any elements that scored below a specific threshold; and, for any elements with a score below the threshold, removing the description of those elements from the input alt-text. In this way, an embodiment may help to ensure that the improved auto-generated alt-text only includes descriptions of the core image elements with no description of decorative elements that is often a problem for the visually impaired user.

### B. Detailed Discussion of Aspects of an Example Embodiment

One example embodiment comprises a context-based score calculation that determines, for various potential objects in an image, whether those objects are relevant or decorative. One embodiment may assume input has been provided that comprises an image, and alt-text corresponding to the image. The alt-text may contain descriptions of spurious/decorative objects in the image. An embodiment may operate to identify those objects, and remove the corresponding descriptions from the alt-text. In an embodiment, a method may comprise the following operations: extracting a list of objects based on descriptions included in alt-text; detecting where the objects are in the image; estimating how relevant each object is; and, creating modified/new alt-text by removing the descriptions of the decorative objects from the alt-text. In an embodiment, the image itself need not be modified, so long as the alt-text is processed to remove description of spurious objects included in the image. Possibly, in an embodiment, the image may be processed, such as by masking for example, to remove or obscure objects identified as irrelevant so that any alt-text generated based on the processed image will not include descriptions of those irrelevant objects.

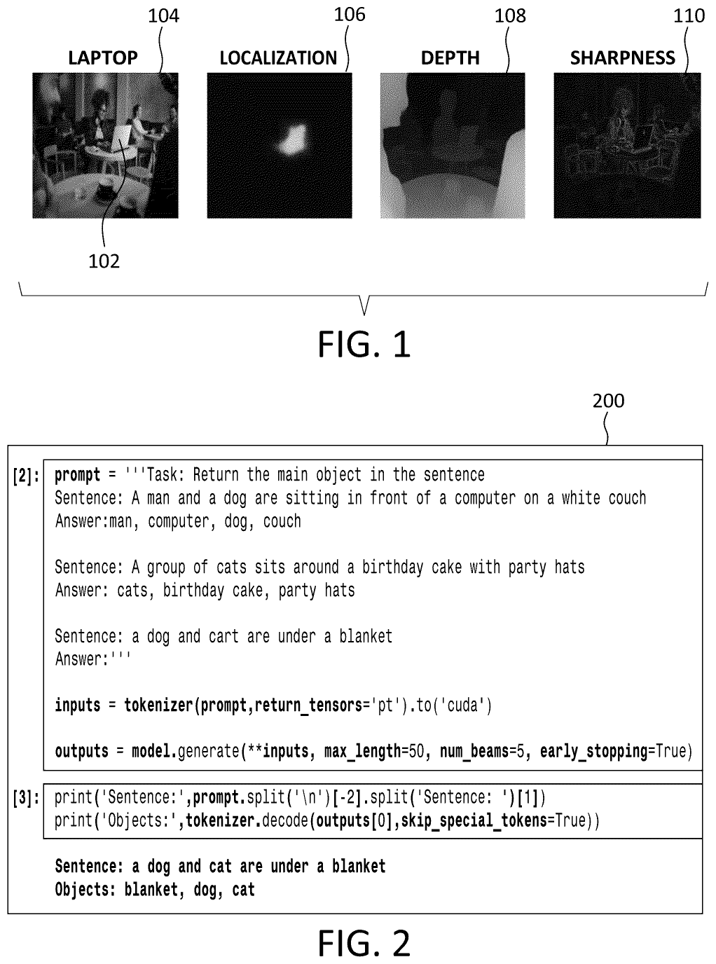

With reference now to the example of FIG. 1, various elements of a method according to one embodiment are disclosed. In this illustrative example, the object under consideration is a ‘laptop’ 102 and the appearance of the laptop 102 in the image 104 may be evaluated with respect to its localization, depth, and sharpness. In the example of FIG. 1, these properties of the object, that is, the laptop 102, as it appears in the image 104, are respectively indicated in a localization heatmap 106, a depth heatmap 108, and a sharpness heatmap 110. Each of these different property evaluations may be performed using different respective techniques, as described below.

### B.1 Object Extraction from Alt-Text

In one embodiment, this operation may comprise using a Question-Answering (QA) Large Language Model (LLM). Various models may be used for this purpose such as, for example, the open-source Flan-T5. To perform the extraction itself, an embodiment may use a combination of prompt engineering and a few shot prompting. An example prompt 200 that may be used in one embodiment is disclosed in FIG. 2. In the example of FIG. 2, the prompt 200 may present a few examples to a model, such as an LLM, and allows the model to pick up, from the context in the alt-text, that it, that is, the model, should extract certain object descriptions from the alt-text. Note that the prompt 200 is presented only by way of example, and need not be used in every case. More generally, the prompt used in any particular case may vary according to the model that is used for the extraction. It is noted further that the example prompt 200 performed well in connection with the Flan-T5 model in experiments performed by the inventors.

### B.2 Detecting where the Objects are in an Image

After the object descriptions have been identified in, and extracted from, alt-text, those descriptions may be mapped to objects known to exist in the object. At this stage, the image may then be evaluated to determine where, in the image, those objects are located. For this task, there are a number of possible approaches, one example of which is a zero-shot semantic segmentation (ZSSS) process.

In an embodiment, it may be easier to use off-the-shelf pretrained models while not requiring any sort of specific labeling or fine tuning to new classes. The advantage of semantic segmentation, such as ZSSS, over bounding box detection semantic segmentation that it gives more accurate representations of where objects are in the image down to the pixel level, which helps in the subsequent steps. Put another way, semantic segmentation may embody a more granular approach to object location identification than a bounding box approach, where a bounding box may embrace thousands, or more, of pixels.

One example open-source model that may be used to perform ZSSS is ClipSeg, which is a segmentation model based on the CLIP (contrastive language-image pre-training) multi-modal transformer. In general, ClipSeg has learned to represent both text and images in a shared internal space, and it can find objects corresponding to a given text within an image in a zero-shot fashion.

### B.3 Estimating Object Relevance

In order to estimate the relevance of each object of interest in an image, an embodiment may tie object relevance to certain characteristics of how that object is displayed in the image. Namely, if an object is extremely blurred/out of focus, very far away from the center of the image, or very far in the background of the image, an embodiment may assume that the object is relatively less relevant than, for example, an object that is closer to the center of the image and/or is not as blurry. An embodiment may comprise a process for numerically determining, or quantifying, all of these object relevance characteristics

### B.3.1 Centrality Score

In an embodiment, in order to determine how centralized a given object is on an image, the pixels corresponding to that object may be first obtained through ZSSS, and then the center of mass (COM) of that object may then be determined. In an embodiment, the COM of an object may be defined as the mean value of its x and y pixel coordinates. Then, the Euclidean distance from the COM to the center of the image (d_{com}) may be determined.

In order to normalize this quantity between 0 and 1, one embodiment may determine the maximum possible distance between any pixel in the image and the center (dₘₐₓ) and divide d_{com} by dₘₐₓ. The resulting quantity may then be subtracted from 1 to obtain a score that is 0 when the center of mass is centralized, and 1 when the center of mass is close to dₘₐₓ:

$${s}_{centrality} = 1 - \frac{{d}_{com}}{{d}_{max}}$$

In the example case of a square image, dₘₐₓ is half the diagonal of the square.

### B.3.2 Depth Score

In one embodiment, a depth score for a given object in an image may also be based on the semantic segmentation pixels for those objects. Once a depth map is computed by a depth estimation model such as, for example, Intel/dpt-large, the depth for each pixel belonging to an object can be then averaged. Similar to the case of the centrality score, the depth scores for each object may be normalized between 0 and 1 to make it easier to scale the respective contributions of each of the depth scores relative to one another.

### B.3.3 Sharpness/Blur Score

Determining how blurry an object is in an image is a deceptively complex task. There may not be a single best method to estimate this, and some methods are better suited for certain types of images than other types of images. Thus, the best particular method for determining how blurry an image is may be use-case dependent. One example embodiment may implement a sharpness score approach by blurring an image with a Gaussian blur and then subtracting the blurred image from the original, unblurred, image.

To illustrate, with reference to the Gaussian blur approach, once the Gaussian blur is applied to an image, regions that were previously sharp become blurry, and regions that were already blurry typically do not change as much. This change observed in the sharp portions of the image may be quantified as the absolute value of the difference between the original image and the blurred image. The result can be plotted, as illustrated by the sharpness heatmap 110 in FIG. 1, where the salient regions are the ones that are sharpest in the sharpness heatmap 110. In an embodiment, the values of a heatmap, such as the sharpness heatmap 101, may be normalized between 0 and 1, and the sharpness score for an image then computed as the average sharpness value for all pixels within the pixels detected, such as by the ZSSS, as belonging to that object.

### B.3.4 Additional Sub-Scores

The three object relevance sub-scores discussed here, that is, the centrality score, the depth score, and the sharpness/blur score, are by no means an exhaustive list, and different applications may employ additional, or alternative, sub-scores that make the relevance of a given object of an image more salient. Moreover, in an embodiment, the same procedure may be followed, however, to create a sub-score value. Namely, ZSSS may be applied to detect the pixels that belong to an object, and the metric(s) of choice then averaged over all detected pixels.

### B.3.5 Thresholding

In an embodiment, one, some, or all, of the object relevance sub-scores may have an associated respective threshold which, in an embodiment, may be set by human experts for a given use-case. A rule-based approach may then be used to determine whether the objects in an image should be included, or excluded, based on a comparison of their relevance sub-scores with the applicable thresholds. For example, if a sub-score falls below a threshold, it may be deemed that the object with which that sub-score is associated is not relevant such that the description of that object should be removed from the alt-text associated with an image that includes the object.

### B.4 Removing Decorative, or Irrelevant, Objects

Once a set of one or more objects of an image has been determined to be irrelevant/decorative, the initial label, captured in the alt-text, describing the image may be updated to remove references to the decorative objects. In one embodiment, this may be achieved by using a sequence-to-sequence language model. In the case of some experiments run by the inventors, the architecture used was Flan-T5, although various other suitable LLM(s) may be employed for this purpose.

To make Flan-T5, for example, remove the object description(s) from a sentence of alt-text, few-shot prompt-engineering may be used. This means that a relatively small number of examples, such as three for example, may be shown to the model demonstrating the expected behavior, and a fourth example is the actual sentence, that is, alt-text, to be analyzed and possibly modified. In an embodiment, the few-shot prompts may employ the following general template:
Sentence: <Original sentence, containing decorative objects>
Remove: <Objects to be removed>
Result: <Sentence with decorative objects removed>.

### C. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

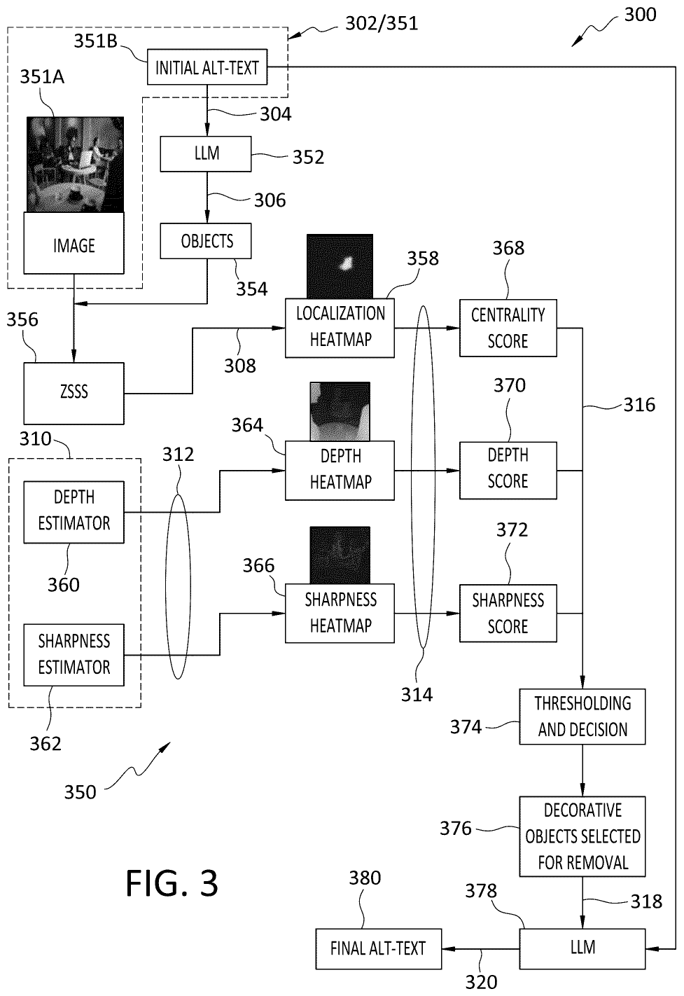

Directing attention now to FIG. 3, a method 300, and architecture 350, according to one embodiment, are disclosed. The example method 300 may be performed on-premises at the site of an organization, or may be performed at a cloud-site and provided to customers as-a-Service (aaS) in which the customers provide input to the cloud service, such as images and associated alt-text, and receive, as an output from the cloud service, modified alt-text. The scope of this disclosure is not limited to any particular implementation however.

In an embodiment, the method 300 may begin with the receipt 302 of input 351 comprising an image 351A and alt-text 351B that was generated based on that image 351A. After receipt 302 of the input 351, the method 300 may designate 304 an LLM 352, or other model, for use in identifying and extracting 306 one or more object 354 descriptions, each corresponding to and identifying a respective object, from the alt-text 351B that was received as part of the input 351. The extracted object descriptions 354 may then be used to determine, such as with centrality estimator 356, which may comprise a ZSSS approach, where, in the image 351A, the identified objects are located. The locations of the objects may then be used to generate 308 a localization heatmap 358.

When the objects have been located in the image 351A, and based on the locations of those objects, various other processes 310 may be performed to establish a respective relevance of each object. Such processes 310 may be performed, for example, by a depth estimator 360, and a sharpness estimator 362.

The various estimators, such as the depth estimator 360 and a sharpness estimator 362, may each generate a respective output that may comprise a depth heatmap 364, and a sharpness heatmap 366. Each of the heatmaps, including the localization heatmap 358, the depth heatmap 364, and the sharpness heatmap 366, may be used to generate 314 a respective score, namely, in this example, a centrality score 368, a depth score 370, and a sharpness score 372.

The various scores 368, 370, and 372, may then be input 316 to a thresholding module 374 for evaluation. In an embodiment, the evaluation may comprise comparing each score to a respective threshold, such as a relevance threshold, to determine whether or not the score meets or exceeds the threshold. If a score does not meet or exceed its relevance threshold, then that score may be deemed to refer to an irrelevant, rather than relevant, object in the image 351A. The thresholding module 374 may then output a list 376 of irrelevant objects.

The list 376 may then be provided 318 to a model 378, such as an LLM for example. Using the list 376, the model 378 may then parse 320 the alt-text and remove the text which corresponds to the objects identified in the list 376 of irrelevant objects. Removal of that text results in a final alt-text 380 that is a modified version of the alt-text 351B that was initially input.

### D. Further Discussion

As apparent from this disclosure, one or more embodiments may possess various useful features and aspects, although no embodiment is required to possess any of such features and aspects. The following examples are illustrative. An embodiment may provide improved alt-texts for enhanced accessibility of web content for users who may be visually impaired. An embodiment may focus specifically on context-based detection of spurious or decorative objects on image descriptions for removal. An embodiment may combine various components to define a relevance score indicating the relevance of an object in an accessibility context.

Embodiments may be implemented in various ways. For example, an embodiment may be implemented as, or in, a web browser plugin operable to generate, and present to a user by way of the web browser, alt-text for images accessed, displayed, and/or displayable by, a web browser. An embodiment may be implemented as a local, and/or remote, service that can be called by a web browser as needed to generate alt-text for one or more web images. The functionality provided by an embodiment may be automatically called by a web browser that is operating in a mode configured to users with visual impairment. These implementations are provided only by way of example, and are not intended to limit the scope of this disclosure, or the scope of any claims presented at any time in this application, in any way.

It is noted that various terms are used herein. Following are definitions for some of these terms. Decorative element: an element of an image that does not add value to user understanding of an image and the context of that image. Alternative Text (Alt-text): the written copy that appears in place of an image on a webpage if the image fails to load or in cases where the user is visually impaired. Search Engine Optimization (SEO): maximizing the number of webpage visitors by ensuring it appears high on the list of results in a search engine results page.

### E. Further Example Embodiments

Following are some further example embodiments. These are presented only by way of example and are not intended to limit the scope of this disclosure or the claims in any way.

Embodiment 1. A method for improving a textual description, comprising: receiving an image and alt-text, and the alt-text has been generated based on the image; extracting, from the alt-text, a description of an object that is included in the image; detecting in the image, using the description, where the object is located; estimating a relevance of the object; and when the relevance fails to meet a relevance threshold, generating modified alt-text by removing the description of the object from the alt text.

Embodiment 2. The method as recited in any preceding embodiment, wherein the image comprises a website image.

Embodiment 3. The method as recited in any preceding embodiment, wherein the modified alt-text is presented to a user when the user navigates to a web page that includes the image.

Embodiment 4. The method as recited in any preceding embodiment, wherein estimating a relevance of the object comprises obtaining respective relevance scores for each relevance measure in a group of relevance measures.

Embodiment 5. The method as recited in any preceding embodiment, wherein estimating a relevance of the object comprises generating a respective heat map for each relevance measure in a group of relevance measures and, based on the heat map, generating a respective score for each relevance measure and comparing the scores to respective thresholds to determine the estimated relevance of the object.

Embodiment 6. The method as recited in any preceding embodiment, wherein the extracting of the description of the objection is performed using a Question-Answering (QA) Large Language Model (LLM).

Embodiment 7. The method as recited in any preceding embodiment, wherein the detecting is performed using a zero-shot semantic segmentation (ZSSS) process.

Embodiment 8. The method as recited in any preceding embodiment, wherein estimating a relevance of the object comprises determining a centrality score for the object, and the centrality score is based on a center of mass (COM) of the object.

Embodiment 9. The method as recited in any preceding embodiment, wherein estimating a relevance of the object comprises determining a depth score for the object, and the depth score is based on semantic segmentation pixels identified as part of the detecting.

Embodiment 10. The method as recited in any preceding embodiment, wherein estimating a relevance of the object comprises determining a blur score for the object.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

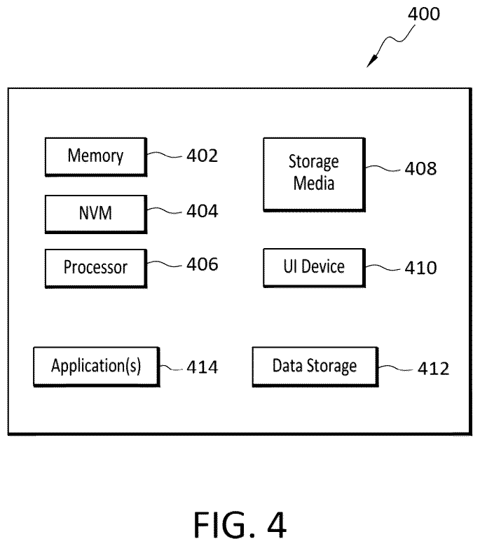

With reference briefly now to FIG. 4, any one or more of the entities disclosed, or implied, by FIGS. 1-3, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for improving a textual description, comprising:
receiving an image and alt-text, and the alt-text has been generated based on the image;
extracting, from the alt-text, a description of an object that is included in the image;
detecting in the image, using the description, where the object is located;
estimating a relevance of the object; and
when the relevance fails to meet a relevance threshold, generating modified alt-text by removing the description of the object from the alt-text.

2. The method as recited in claim 1, wherein the image comprises a website image.

3. The method as recited in claim 1, wherein the modified alt-text is presented to a user when the user navigates to a web page that includes the image.

4. The method as recited in claim 1, wherein estimating a relevance of the object comprises obtaining respective relevance scores for each relevance measure in a group of relevance measures.

5. The method as recited in claim 1, wherein estimating a relevance of the object comprises generating a respective heat map for each relevance measure in a group of relevance measures and, based on the heat map, generating a respective score for each relevance measure and comparing the scores to respective thresholds to determine the estimated relevance of the object.

6. The method as recited in claim 1, wherein the extracting of the description of the objection is performed using a Question-Answering (QA) Large Language Model (LLM).

7. The method as recited in claim 1, wherein the detecting is performed using a zero-shot semantic segmentation (ZSSS) process.

8. The method as recited in claim 1, wherein estimating a relevance of the object comprises determining a centrality score for the object, and the centrality score is based on a center of mass (COM) of the object.

9. The method as recited in claim 1, wherein estimating a relevance of the object comprises determining a depth score for the object, and the depth score is based on semantic segmentation pixels identified as part of the detecting.

10. The method as recited in claim 1, wherein estimating a relevance of the object comprises determining a blur score for the object.

11. A non-transitory storage medium having stored therein instructions that are executable by one or more hardware processors to perform operations for improving a textual description, and the operations comprise:
receiving an image and alt-text, and the alt-text has been generated based on the image;
extracting, from the alt-text, a description of an object that is included in the image;
detecting in the image, using the description, where the object is located;
estimating a relevance of the object; and
when the relevance fails to meet a relevance threshold, generating modified alt-text by removing the description of the object from the alt-text.

12. The non-transitory storage medium as recited in claim 11, wherein the image comprises a website image.

13. The non-transitory storage medium as recited in claim 11, wherein the modified alt-text is presented to a user when the user navigates to a web page that includes the image.

14. The non-transitory storage medium as recited in claim 11, wherein estimating a relevance of the object comprises obtaining respective relevance scores for each relevance measure in a group of relevance measures.

15. The non-transitory storage medium as recited in claim 11, wherein estimating a relevance of the object comprises generating a respective heat map for each relevance measure in a group of relevance measures and, based on the heat map, generating a respective score for each relevance measure and comparing the scores to respective thresholds to determine the estimated relevance of the object.

16. The non-transitory storage medium as recited in claim 11, wherein the extracting of the description of the objection is performed using a Question-Answering (QA) Large Language Model (LLM).

17. The non-transitory storage medium as recited in claim 11, wherein the detecting is performed using a zero-shot semantic segmentation (ZSSS) process.

18. The non-transitory storage medium as recited in claim 11, wherein estimating a relevance of the object comprises determining a centrality score for the object, and the centrality score is based on a center of mass (COM) of the object.

19. The non-transitory storage medium as recited in claim 11, wherein estimating a relevance of the object comprises determining a depth score for the object, and the depth score is based on semantic segmentation pixels identified as part of the detecting.

20. The non-transitory storage medium as recited in claim 11, wherein estimating a relevance of the object comprises determining a blur score for the object.
